(19) United States
(12) Patent Application Publication
(10) Pub. No.: US 2005/0010790 A1
(43) Pub. Date: Jan. 13, 2005

(54) Cryptographic module for the storage and playback of copy-protected electronic tone and image media which is protected in terms of use

(76) Inventors: Juergen K Lang, Bergisch Gladbach (DE); Ursula Maria Bing, Bergisch Gladbach (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/495,383

(22) PCT Filed: Dec. 4, 2002
(86) PCT No.: PCT/DE02/04435

(30) Foreign Application Priority Data
Dec. 30, 2001 (DE) 101641311

(51) Int. Cl. H04L 9/32

(52) U.S. Cl. 713/193

(57) ABSTRACT

The invention relates to a cryptographic module for storing and playing copy-protected and utilization-protected electronic audio and video media at a recipient, whereby the recipient's legitimate scope of utilization is regulated and enforced by the module. According to the invention, this objective is achieved in that the cryptographic module at the recipient completely or partially decrypts or deciphers encrypted or enciphered data contents of electronic audio and video media or else keys for decrypting these data contents—while observing the utilization rights and utilization conditions—and subsequently re-encrypts or re-enciphers them for purposes of storage or playback in such a way that license fees can be charged based on the utilization.

The invention relates to a cryptographic module for storing and playing copy-protected and utilization-protected electronic audio and video media at a recipient, whereby the recipient's legitimate scope of utilization is regulated and enforced by the module.

It is known that cryptographic modules are used in many areas of data processing precisely where data contents or electronic processes are supposed to be specifically protected against unauthorized manipulations.

The special shielding of cryptographic modules against the surrounding processes and systems of data processing prevents data contents from being read out without authorization (protection of confidentiality) or changed without authorization (integrity protection). Moreover, it is prevented that relevant processes can be initiated without authorization.

Known areas of application are, for example, in the use of cryptographic modules in the form of chip cards as an electronic purse with a stored cash value (example: cash card) or as authentication protection (e.g. in cellular telephones). In both cases, dispensing with a cryptographic module would be associated with considerable security risks since the otherwise unprotected data could be read out or manipulated (example: unauthorized increase of the stored cash value of the cash card or copying of the cellular phone authentication key in order to fraudulently make phone calls at the expense of the actual owner).

Therefore, cryptographic modules have to be able to ward off manipulation attempts or to temporarily interrupt or permanently terminate their own functionality when a manipulation is discovered.

The American standard “FIPS PUB 140” has evolved into an important standard for the development and use of cryptographic modules that is recognized worldwide. This standard, issued by the U.S. Department of Commerce and by the National Institute of Standards and Technology in the United States (NIST for short), defines the requirements made of cryptographic modules on the basis of four different security levels 1-4 for mandatory use in computer-based security systems for public organizations in the United States. “FIPS PUB 140” stands for “Federal Information Processing Standards Publication, No. 140; this document can be obtained free of charge, that is to say, it can be downloaded electronically from the Internet at the following address http://www.nist.gov or http://csrc.nist.gov/cryptval/.

Standard FIPS PUB 140 specifies “Security Level 1” as the lowest security level for a cryptographic module. The most important feature of Level 1 is the total absence of “physical security” (for example, by means of external seals, etc.). Moreover, by complying with the requirements set forth in the standard, a normal PC can be used to carry out cryptographic processes at a low security level.

Standard FIPS PUB 140 specifies “Security Level 2” as the second-lowest security level for a cryptographic module. In contrast to Level 1, now a physical sealing or locking of the module is provided (tamper-evident coating or seals, or pick-resistant lock). At this security level, such seals serve merely to show whether an unauthorized physical access to the module or opening of the module has taken place. Another important difference from Level 1 is that a role-based authentication of the user has to be carried out. In actual practice, this security level is a popular security choice since it has a well-balanced relationship between security requirements and costs. However, experts feel that the security it offers is inadequate when it comes to high-security applications such as the generation of digital signatures and for the secure use of sensitive cryptographic information.

Standard FIPS PUB 140 specifies “Security Level 3” as the second-highest security level for a cryptographic module. In contrast to Level 2, numerous security measures are required starting with Level 3. Once again, an essential measure relates to physical security. At this security level, seals are to be applied in such a way that their manipulation or opening causes the information present in the cryptographic module to be deleted. Consequently, an attempt to gain unauthorized access to a cryptographic module of Level 3 leads to the destruction or deletion of the module. Moreover, starting with Level 3 and above, an authentication of the user is required on an individual basis. Furthermore, security-relevant interfaces of the module have to be physically separated. As a rule, parameters of the cryptographic module have to be transferred into the module in encrypted form or taken out of the module in encrypted form, etc. As a result of all of these measures, a cryptographic module of Level 3 is considered by experts to be very secure.

Standard FIPS PUB 140 specifies “Security Level 4” as the highest security level for a cryptographic module. In contrast to Level 3, the maximum level of security measures currently attainable is required in Level 4. This is achieved by a second firewall around the actual cryptographic module, the so-called “envelope”. Already if the outer envelope is breached (e.g. physical severing), this attempted attack is supposed to be actively discovered and lead to an autonomous deletion of the data contents. The cryptographic module of Level 4 monitors itself so to speak and, in case of an attack, it autonomously decides to delete its security-relevant contents. Moreover, the module of Level 4 is secured against contact-free attacks from the surroundings, for example, by temperature fluctuations and electromagnetic influences.

With an eye towards the applications and processes needed in the cryptographic module in the present case, four application types of cryptographic modules can be looked at for comparison purposes:

A) Cryptographic module for secure storage of information.
Examples of cryptographic modules that serve to securely store information are electronic ID cards and cards for storing cash values. The main objective of such cryptographic modules is to store certain information within a secured area (of the cryptographic module) in such a way that an unauthorized manipulation of this information is not possible without destroying the cryptographic module and thus the information contained therein. Actually, cryptographic processes would not be necessary with this application since it is not the main objective of the cryptographic module to carry out an encryption or decryption of data. However, since recording, querying and especially changing the information that is to be securely stored is associated with transactions with adjacent, unsecured systems, such data import and export processes are generally safeguarded by secure authentication, that is to say, through the use of encryptions and signatures.

B) Cryptographic modules for carrying out cryptographic encryption/decryption processes and signature.
The high-quality cryptographic modules that will probably be the most widespread in the future are the so-called signature cards. Their main functions are to decrypt dedicated data (generally text data) or to provide said data with a digital signature. The essence of these cards is one or two asymmetrical pairs of keys for decrypting/encrypting and for generating and checking signatures. The quite simple underlying principle consists in once again decrypting a received file that had previously been encrypted by the communication partner with his own public key (that is to say, with the key of the recipient) by using the appertaining private key contained in the cryptographic module. In contrast, when a digital signature is generated, the private key that is contained in the cryptographic module is used to encrypt a so-called digital fingerprint (so-called “hash value”) of the text that is to be signed. A characteristic of such cryptographic modules is the batch-wise input of the complete useful data into the cryptographic module in batch operation (each file has a defined beginning and end; the processing is not carried out in real time but rather generally as a function of the processor capacity according to the principle of the “best effort”). However, the use of such signature cards as cryptographic modules for decrypting and encrypting audio and video data would not be possible on the basis of the current state of the art. First of all, for the present application case of the secure decryption of very extensive audio and video media, a cryptographic module, for example, according to FIPS PUB 140, Security Level 3, would either be sufficient in terms of the required computing power to carry out the cryptographic processes, but in this case, not suitable for the market of consumer electronics because of the very high costs involved, or else it would be affordable, for example, in the form of a chip card or a PC “dongle”, but would not have an adequate capacity to perform the computing operations. Secondly, the problem would exist that it would have to be possible to decrypt broadcast media data, even without a recognizable limitation of the continuous data stream (no defined beginning and no precise end, for example, in the case of television or radio). Existing cryptographic modules for carrying out cryptographic processes of encryption/decryption and signature are not capable of doing this.
Moreover, with such cryptographic modules, there are no processes for charging license fees available at all.

C) Cryptographic modules for special application purposes.
Cryptographic modules can be further improved for special application purposes. An important example is the patent for a “Security module and method for producing forgery-proof documents”, which is likewise held by the applicant of the present cryptographic module. German Patent DE 100 20 561 C2 discloses a cryptographic module that is a central component of the so-called “PC franking” of the Deutsche Post (German Postal System) for producing electronic “Internet” stamps. Expanding on the prior-art cryptographic modules, this security module generates a random number that is transferred via a secure channel to a central location of the Deutsche Post and that is transmitted back again with an encryption known only to the Deutsche Post. At the time of the later production of postage indicia on the PC, the individual data of a franking (including the value of postage, date, postal class, parts of the address), together with the temporarily stored random number, are subjected to the formation of a digital fingerprint (“hash value”). This hash value and the random number encrypted by the central location are attached to each franking. When the postage indicium is later checked, the Deutsche Post can decrypt the random number and can reproduce the digital finger-print created in the cryptographic module so as to compare it to the fingerprint that was transmitted. In this manner, the authenticity of the postage indicium can be checked.
However, for a number of reasons, even this approach involving a cryptographic module for the Internet stamps of the Deutsche Post cannot be used for decrypting and encrypting audio and video data or for charging license fees:
In addition to the likewise limited and non-expandable application purpose, namely, for producing forgery-proof documents or stamps, the processing of complete media data in real time would not be possible due to the lack of limitation of the continuous data stream (no defined beginning and no precise end, for example, in the case of television or radio) and neither would a process be possible for re-encrypting encrypted audio and video data.
Another indication of fundamental functional differences between the cryptographic module under discussion here and the security module of the Deutsche Post is the total absence of the external verification station, which is generally essential, especially for the security module of the Deutsche Post, and which is used to determine the authenticity or integrity of the documents or stamps generated with the cryptographic module. This basic functionality does not exist at all in the present case.
In view of the fact that the applicant of this patent is the same as the inventor of the above-mentioned patent of the Deutsche Post, it must be explicitly pointed out that the inventions for the application purposes of generating Internet stamps on the one hand and encrypting audio and video information on the other hand differ markedly with respect to the tasks of the respective cryptographic modules.

D) Cryptographic modules for processing audio and video data.
A weakened variant of a cryptographic module that can fall under this concept, at least in the broadest sense, is that of the so-called decoder for encrypted television broadcasts (“Pay TV”). In contrast to high-quality cryptographic modules, as a rule, these decoders are produced so as to be completely identical (that is to say, not customer-specific) and are not based on a cryptographic-analytical encryption but rather on an element of obscurity (in the case of high security requirements, such “security by obscurity” is rejected by experts since more secure methods without obscurity exist). Moreover, with such decoders, the structural design also ensures the security (physical security) in such a way that opening the sealed decoder results in its destruction. Taking the standards of the FIPS 140 Standard, as a basis, it is evident that the decoder is used at best role-specifically but not individually. In view of this fact alone, such a decoder could at best reach security level 2 (although only if an authentication of the user is carried out, and this is extremely unusual for the use of decoders). Consequently, the absolutely requisite individuality of different cryptographic modules, which is required for the cryptographic module under discussion here, could not be reconciled with this. Moreover, there would be no processes for charging license fees in the case of known decoders which, as a rule, are distributed on a subscription basis and/or for a one-time fee.

In the known cryptographic modules, the problem exists that they are not suitable for decrypting and encrypting copy-protected and utilization-protected audio and video media and their data contents with the objective of charging utilization-based license fees. The cryptographic modules used so far serve either for the secure storage of information (e.g. identification card, cash card), for the encryption/decryption and signature of dedicated useful data (signature card, as a rule for text data), for generating forgery-proof documents (e.g. electronic stamps) or for decoding encrypted television signals (“Pay TV”). In contrast, cryptographic modules are not known for the present application purpose!

The invention is based on the objective of further improving systems and processes of the generic type in such a way that the required combination of secure storage and cryptographic processing of streaming information with individual keys is performed by a cryptographic module practically in real time (in contrast to batch processing).

According to the invention, this objective is achieved in that the cryptographic module at the recipient completely or partially decrypts or deciphers encrypted or enciphered data contents of electronic audio and video media or else keys for decrypting these data contents—while observing the utilization rights and utilization conditions—and subsequently re-encrypts or re-enciphers them for purposes of storage or playback in such a way that license fees can be charged based on the utilization.

An advantageous embodiment of the cryptographic module is characterized in that the authorization to use the cryptographic module to play and store audio and video media, to view and change utilization conditions and to charge for license fees is checked by means of the authentication of the legitimate user before the actual operation is carried out.

It is advantageous for the reliability of the audio and video media to be checked inside the cryptographic module on the basis of the validity of the certificate—issued by a credible certification authority—of a key of the publisher of the audio and video media, whereby this checking procedure is done by means of a test key of the certification authority that is saved in the cryptographic module.

It is advantageous for the reliability of the portable device to be checked inside the cryptographic module on the basis of the validity of the certificate—issued by a credible certification authority—of the portable device, whereby this checking procedure is done by means of a test key of the certification authority that is saved in the cryptographic module.

It is advantageous for the reliability of electronic communication partners to be checked inside the cryptographic module on the basis of the validity of the certificate—issued by a credible certification authority—of the communication partners, whereby this checking procedure is done by means of a test key of the certification authority that is saved in the cryptographic module.

It is advantageous for the communications received from reliable electronic communication partners for the utilization of audio and video information to be checked inside the cryptographic module for the validity of the applied digital signatures and to be decrypted there.

It is likewise advantageous for the communications that are to be sent to reliable electronic communication partners and that are meant for the utilization of audio and video information to be encrypted inside the cryptographic module and provided with their own digital signature there.

A practical version of the cryptographic module is that, while avoiding the processing of extensive audio and video data inside the cryptographic module, only key data for the decryption of this audio and video data is processed.

Here, it is advantageous for each processing of key data into encrypted audio and video information inside the cryptographic module to lead to a decryption and subsequent different encryption of this key data—while the utilization conditions are observed.

It is advantageous that the previous use of a user-related key employed by the cryptographic module itself to encrypt the audio and video data can be recognized and can be reversed again for purposes of playback.

It is advantageous for the utilization conditions that were supplied with the audio and video data and that pertain to playing or storing this data to be stored in the cryptographic module as the basis for re-encrypting procedures and license fee billing that are to be carried out.

It is likewise advantageous for the utilization rights and the utilization conditions to be stored temporarily or permanently inside the cryptographic module so that, during the further utilization, they can serve as a decision-making basis for the playing, storing or license fee billing.

An advantageous embodiment of the cryptographic module is that the license fee billing is done inside the module in such a way that the license fee billing can proceed in accordance with the utilization conditions, exclusively within the scope of the legitimate utilization, when re-encrypting procedures are carried out.

It is also advantageous for the use, in accordance with the license, of a user-related key for re-encrypting keys in order to play audio and video information to be stored inside the cryptographic module, marking the specific section of the specific audio and video information with the identification of the release that has been effectuated in accordance with the license.

It is also advantageous for the use, in accordance with the license, of a user-related key for re-encrypting keys in order to play audio and video information to be stored outside of the cryptographic module, marking the specific section of the specific audio and video information with the identification of the release that has been effectuated in accordance with the license and provided with a digital signature by the cryptographic module.

Finally, it is advantageous for the cryptographic module to be operated together with a PC-based application program that supports the transactions for use in accordance with the license by providing a graphic user interface.

Additional advantages, special features and practical embodiments of the invention ensue from the subclaims and from the presentation below of preferred embodiments.

The present method and system is to be introduced by several companies in the media industry under the project designation “m.sec”. Below, the special features of m.sec are described.

With the advent of methods and systems for digital audio and video storage, a new level of sound media piracy arose: through so-called “sampling”, the audio and video signals, which had previously existed only in analog form, were unambiguously quantified within the scope of digitalization. Thanks to this unambiguous quantification, for example, in the form of bits and bytes with unambiguous values, perfect copies could be produced for the first time which could no longer be distinguished from the original and which thus suffered no qualitative degradation.

After sound media piracy had already acquired a substantial scope in the form of illegally produced CD copies with the spread of the compact disc, this piracy intensified even further with the advent of the Internet. Due to the large data volume, this was not so much a case of CD copies or audio files in the CD format but rather, sound media piracy was facilitated by a new data format, with which—due to its great compressability—small files could be created that could easily be exchanged via the Internet: the so-called “MP3” format.

MP3 was particularly promoted by the Internet swap network “Napster” which—partially on the edge of legality and partially outside of the law—offered allegedly private exchange transactions between Internet users in a public framework, thereby fostering the illegal transmission of music titles to third parties.

At the latest since MP3 and Napster, the media industry has felt that there is a greater need for a new data format for audio and video data. M.sec meets this need by offering the following advantages:
Digital audio and video data is no longer published unencrypted so that no perfect pirated copies of this original data can be produced.
The audio and video data at the recipient is only decrypted in exchange for payment of a user fee.
Here, variable user fees can be charged.
It is also possible to play parts of the audio and video data (e.g. the first few seconds of a piece of music or the lead of a film) without payment of a user fee.
It is possible to play any parts of the audio and video data without payment of a user fee but with a diminished quality.
The encrypted audio and video data can be provided with certain utilization rights (e.g. the number of times it can be played and copied) as well as other additional information.
When the audio and video data are played, the data is likewise not transferred unencrypted. Decryption only takes place at the time of the so-called digital-analog conversion (D/A conversion).
With the appropriate utilization rights, the recipient can create copies of the audio and video data after payment of a user fee.
These personal copies of the audio and video data are “released” and from then on can be played without further payment of license fees.
Such copies of the audio and video data that the recipient has created after payment of a user fee cannot be readily used by other recipients.

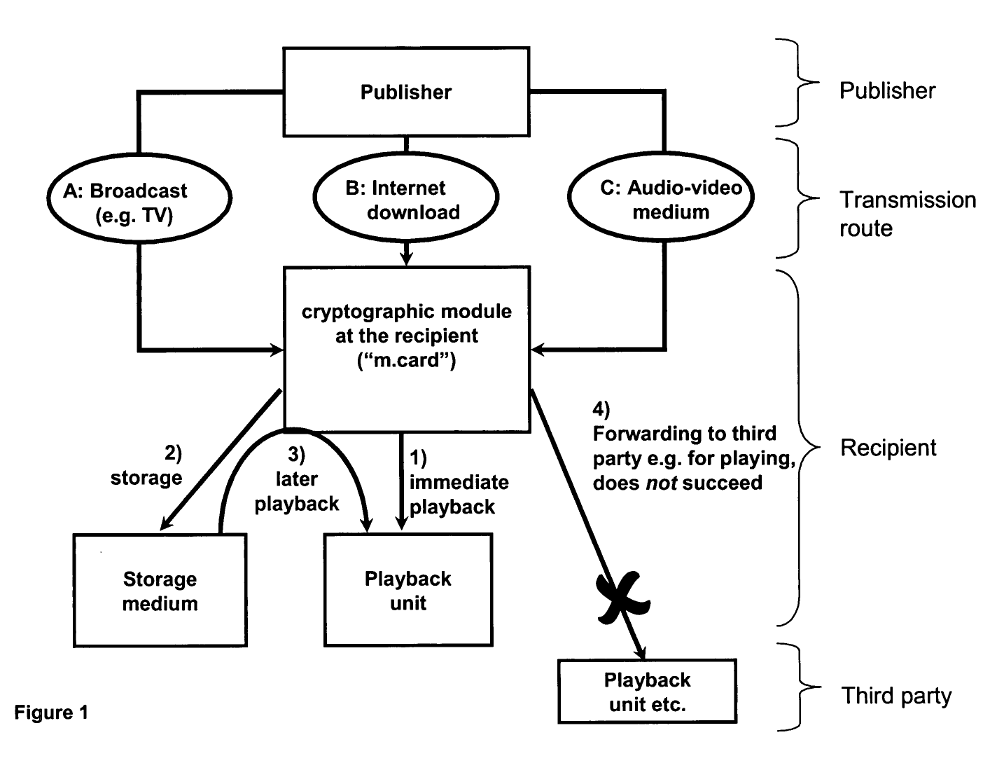

In order to meet these requirements, m.sec comprises the following architecture:
The so-called “publisher” distributes electronic audio and video data that is entirely or partially encrypted. (see “publisher” in FIG. 1)
The recipient has an individual, personalized chip card (the so-called m.card) which, as a cryptographic module, provides functionalities that the recipient cannot manipulate (see “cryptographic module at the recipient, m.card” in FIG. 1)
Appropriate playback and display devices (e.g. personal computer, CD player, Walkman, TV, etc.), in conjunction with the insertable chip card (m.card), offer the possibility to correctly play encrypted audio and video data.

FIG. 1 shows the three possible transmission routes, designated as A, B and C:
With transmission route A (e.g. television), there is a continuous and direct reception of the audio and video data, in the extreme case, in an uninterrupted data stream without beginning or end (so-called “streaming”).
With transmission route B, there is a remote transmission of audio and video media (e.g. as an Internet download) as a rule, in the form of dedicated, complete files.
With transmission route C, the audio and video information is available at the recipient on physically provided audio and video media (e.g. CDs or DVDs).

Here, the following scenarios of use are provided:
1. Playback of transmitted audio and video media (e.g. broadcast TV program)
   If completely or partially encrypted contents of audio and video media are to be received and played immediately, then the m.card serves as the re-encrypting instrument between the encryption by the publisher and the playback unit.
   Here, the encryption by the publisher in the m.card is reversed by means of decryption, the right to play is checked and the playback is initiated. As a rule, this re-encrypting is associated with costs that can be administered, for example, in the cryptographic module. In FIG. 1, this corresponds to the transmission route A in conjunction with the measure at the recipient designated by the number 1), namely, immediate playback.
2. Download and personal release of audio and video data for subsequent playback
   If completely or partially encrypted contents are to be loaded, for example, downloaded from the Internet and released for later personal use, then the m.card serves as a re-encrypting instrument between the encryption by the publisher and the personal encryption with the m.card. As a rule, this re-encrypting is associated with costs that can be administered, for example, in the cryptographic module. In FIG. 1, this corresponds to the transmission route B in conjunction with the measure at the recipient designated by the number 2), namely, the local storing of the information.
   Here, the encryption by the publisher in the m.card is reversed by means of decryption, the right to create a local copy is checked, the encryption with the m.card's own key is carried out and the generation of a copy is initiated.
3. Playback of audio and video data that has been provided by the author on physical media
   If completely or partially encrypted contents of audio and video media are to be played which are provided on physical media, then the m.card serves as a re-encrypting instrument between the encryption by the publisher and the playback unit.
   Here, the encryption by the publisher in the m.card is reversed by means of decryption, the right to play is checked and the playback is initiated. As a rule, this re-encrypting is associated with costs that can be administered, for example, in the cryptographic module. In FIG. 1, this corresponds to the transmission route C in conjunction with the measure at the recipient designated by the number 1), namely, immediate playback.
   If the audio and video information is not temporarily stored in the re-encrypted state as shown in Item 2 in FIG. 1, then, for purposes of repeated playback of the data that has not been re-encrypted, the information can be securely saved by means of the first-time decryption of precisely specified audio and video data either in the cryptographic module itself or else outside of the cryptographic module, provided with a digital signature of the cryptographic module.
4. First and repeated playback of personally released audio and video data
   If contents of audio and video media that have been released and encrypted again with the m.card's own key are to be played back, then the m.card serves as the re-encrypting instrument. As a rule, this re-encrypting is free of charge since a one-time fee for the release was already charged at the time of the original storing operation In FIG. 1, this corresponds to the measure at the recipient designated by the number 3), namely, later playback.
   Here, the actual encryption of the m.card is reversed in the m.card by means of decryption and the playback is initiated.
5. Forwarding personally released audio and video data to (unauthorized) third parties
   If contents of audio and video media that have been released and encrypted again with the m.card's own key are forwarded to third parties, then the latter does not have the possibility to decrypt them, so that the production of pirated copies is not possible. In FIG. 1, this corresponds to the measure at the recipient designated by the number 4), namely, forwarding to third parties.
      Forwarding to third parties (optional) of released audio and video data that can be made public again

If contents of audio and video media (e.g. for a separate fee) are released so that they can be made public again and if they are encrypted again with the m.card's own key, then forwarding to third parties is possible. For third parties, however, the possibility of decryption then exists (e.g. for a fee), in the same manner as this is possible for audio and video data that comes directly from publishers.

Use of keys in the entire system

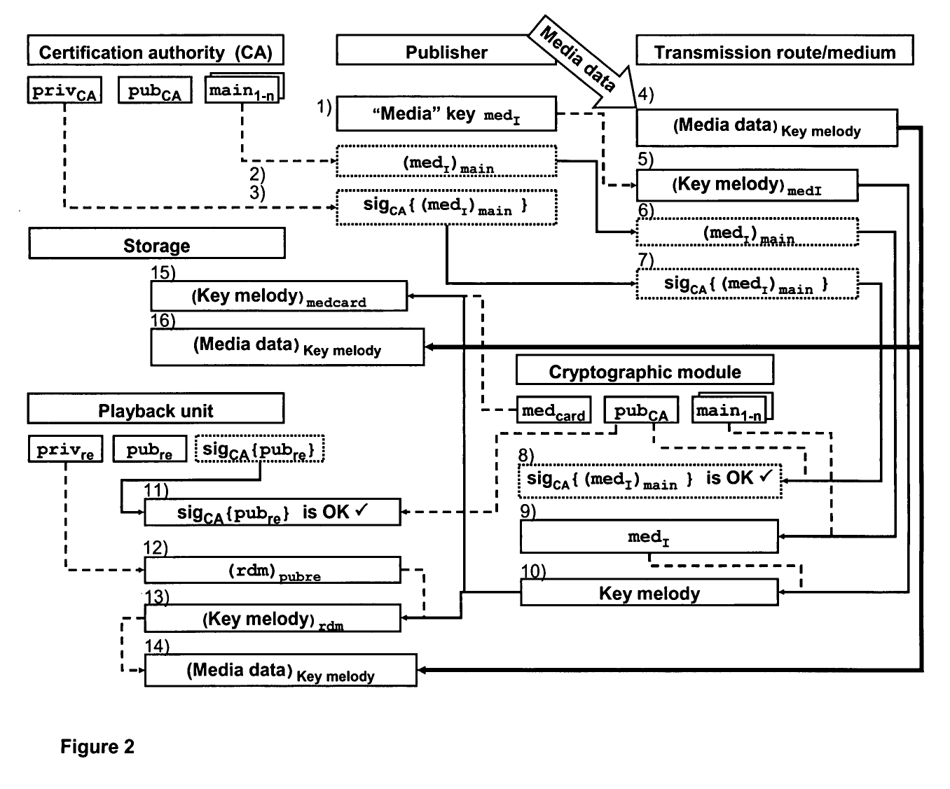

FIG. 2 illustrates the use of keys in the entire system. In addition to the already mentioned participating parties or system components (publisher, transmission channel/medium, cryptographic module m.card, storage and playback unit), there is now a new party, namely, the certification authority (CA) which, as a neutral, trustworthy body or “trust center”, vouches for the issuing of keys.

The following keys are used by the parties:

The certification authority has a so-called first “main” key main₁. Encryptions with this first “main” key can be decrypted with the counterpart to this “main” key, which is present in every m.card. The “main” key is, for example, a symmetrical key according to TDES with a key length of at least 168 bits. As an alternative, keys according to other encryption methods and with other key lengths, e.g. asymmetrical keys with a length of 1024 bits, can also be used, whereby in the case of asymmetrical methods, for example, the private keys are kept in the certification authority and the public key is kept at the cryptographic modules m.cards. In order to enhance the security, when asymmetrical keys are used, the “public” key component in the cryptographic module m.card is not actually made public but rather, in a likewise secure manner, it is introduced into the cryptographic module and would not be ascertainable by the recipient. For security reasons, the “main” key is at least duplicated so that, if need be, the possibility exists in the certification authority as well as in the m.cards to turn to a second or even to additional “main” keys main₂, mainₙ. In order to simplify the description below, regardless of whether symmetrical or asymmetrical keys are used as the “main” key, the symmetrical variant is presented and explained. With the asymmetrical variant, the key main₁ at the certification authority would correspond to the private key and the key main₁ in the cryptographic module would correspond to the matching public key.

In order to encrypt their audio and video media, the individual publishers receive a new “media” key med_{I} from the certification authority, for example, every year (see Step 1 in FIG. 2). This generally symmetrical key indirectly encrypts the data contents, namely, via changing “melody” keys, which is subsequently referred to as the “key melody”, (see further below for explanation). Other encryption methods (e.g. asymmetrical or on the basis of elliptical curves) are also possible. Since the key med_{I} is not available for decryption in the m.card, said key is supplied together with the data contents of the audio and video media, in once again encrypted form. The publisher “media” key is encrypted at the certification authority with the “main” key main₁. The publisher “media” key (med_{I})ₘₐᵢₙ, which is encrypted with the “main” key, is also digitally signed by the certification authority sig_{CA}{(med_{I})ₘₐᵢₙ}. In this process, the certification authority creates a so-called digital fingerprint of the encrypted publisher “media” key and this digital fingerprint is then encrypted with the private signing key of the certification authority priv_{CA} (see Steps 2 and 3 in FIG. 2).

In order to prevent the publisher from calculating the “main” key by means of crypto-analysis or by trying out all possible key combinations, through the presence of the pair consisting of the “media” key and the “media” key that was encrypted with the top-secret “main” key, the publisher only has access to the “media” key in a cryptographic module in such a way that the latter cannot read out the “media” key but can only use it in accordance with the application purpose.

This signature of the certification authority is checked later in the cryptographic module m.card by the self-certificate of the certification authority that is saved there and that contains the public counterpart pub_{CA} of the signing key of the certification authority as well as, in turn, its signature with the signing key. As an alternative, especially if there is a lack of storage capacity in the cryptographic module, it is also possible for only the public key of the certification authority to be saved there. Likewise, in case of a lack of storage capacity, a summary of the two key components, main₁ and pub_{CA}/priv_{CA}, which are present in the certification authority and in the cryptographic module, is possible, although this lowers the security level.

Data contents are now encrypted by the publisher with so-called “melody” keys that change in a time sequence (for instance, every minute or second), and that subsequently form the so-called “key melody”. Advantageously, these changing “melody” keys are random keys according to any desired, for example, symmetrical, method such as TDES with 128 bits. As an alternative, other keys can also be used as random keys (see Step 4 in FIG. 2).

In order to permit the later decryption of the data contents encrypted with the key melody, the key melody is encrypted with the “media” key of the publisher med_{I} and, together with the encrypted audio and video information, transmitted to the recipient via the transmission channel or medium (see Step 5 in FIG. 2). The key melody encrypted with the “media” key is called the “crypto-melody”.

The “media” key (med_{I})ₘₐᵢₙ originally provided to the publisher by the certification authority (see Step 6 in FIG. 2) as well as the certificate or digital signature of the encrypted “media” key sig_{CA}{(med_{I})ₘₐᵢₙ}, likewise provided by the certification authority, are also transmitted to the recipient (see Step 7 in FIG. 2).

Thus, to summarize, at least the following four pieces of information are transferred to the recipient via the transmission channel or via the medium, together with the actual audio and video information (additional information can contain authorizations and utilization information such as, for instance, prices):
Media data encrypted with the key melody: (media data)_{key melody}
The key melody encrypted with the “media” key: (key melody)_{medI},
The “media” key encrypted with the “main” key: (med_{I})ₘₐᵢₙ
The certificate of the “media” key or the digital signature of the “media” key created by the certification authority: sig_{CA}{(med_{I})ₘₐᵢₙ}

Prior to the decryption of the data contents, the “media” key med_{I} is ascertained in the m.card. Since this key is still in encrypted and signed form together with the audio and video media, first of all, the certificate or the signature of the certification authority is checked with the public key of the certification authority pub_{CA} that is present in the m.card (see Step 8 in FIG. 2). Subsequently, the “media” key is decrypted with the “main” key main₁ that is present in the m.card and then used for the decryption operation (see Step 9 in FIG. 2).

Regardless of whether the audio and video media are to be played immediately or else stored temporarily, the crypto-melody is now decrypted into the key melody, making use of the previously decrypted “media” key (see Step 10 in FIG. 2).

This is where the advantage of using changing melody keys that make up the key melody now becomes evident. During the course of processing the data stream of the audio and video data, taking into account the computing capacity of the cryptographic module, only one media key at a time has to be processed in this module, and said key is valid for a specific period of time. Even if one single melody key were to be made public, for example, by crypto-analysis or trial and error, this would only have consequences for a short sequence of audio and video data that would then no longer be protected.

Like the “media” key, the key melody must not be read out. This is ensured through the use of the cryptographic module.

If the audio and video media are to be played immediately, then first of all, the certificate sig_{CA}{pubᵣₑ} issued by the certification authority for the playback unit (or for that model of the playback unit) is transferred from the playback unit to the cryptographic module where it is checked using the saved public key of the certification authority pub_{CA} (see Step 11 in FIG. 2). For practical reasons, as a rule, the asymmetrical keys of the playback unit pubᵣₑ and privᵣₑ are not individually different pairs of keys but rather keys that are changed with each new model of the playback unit and that are identical within each model.

After positive verification, a random or unpredictable temporary playback key rdm is generated in the cryptographic module, then encrypted with the public key of the playback unit (rdm)_{pubre} taken from the previously verified certificate and transferred to the playback unit (see Step 12 in FIG. 2).

Subsequently, in the cryptographic module, the key melody is encrypted with the playback key rdm (see Step 13 in FIG. 2) and, together with the media data that are still encrypted, transferred to the playback unit (see Step 14 in FIG. 2). The playback key thus takes over the function of a temporary “media” key. “Intercepting” the data exchanged between the cryptographic module and the playback unit cannot be used for unauthorized pirated copies since the encrypted key melody cannot be decrypted.

The playback key, with which the key melody can be decrypted and with which finally the media data can be decrypted for final playback, is decrypted in the playback unit.

If the audio and video media are not going to be played immediately but rather first temporarily stored as a local copy, then, after an appropriate verification of the utilization rights, the unencrypted key melody that is present in the cryptographic module is encrypted with a “card” key med_{card} that is individually associated with the cryptographic module and securely saved there (see Step 15 in FIG. 2). The key melody that is thus once again encrypted to form a card-specific crypto-melody is stored, together with the media data that are still encrypted, on any desired data medium, e.g. on the hard drive of a PC (see Step 16 in FIG. 2). This card key functions like a publisher “media” key but as a rule, in contrast to the latter, it does not accompany the audio and video media for security reasons.

In an optional alternative, special card keys as well as the publisher “media” key, can accompany the audio and video media in encrypted form. The card key, like with the publisher “media” key, is encrypted with another “main” key that is present in every key. By the same token, it is advantageous with this alternative to add the encrypted card key to the audio and video media, together with a signature of a certification authority. Through this alternative, the audio and video media encrypted with a card can be played via another card. In this manner, audio and video media can become “re-publishable”, optionally for a fee.

The use of main, media and signing keys reduces the overall risk of corruption of the entire system: by using relatively few “media” keys (e.g. one per publisher per year), the sensitive “main” key is used as little as possible, as a result of which the discovery of the key within the scope of crypto-analysis is made more difficult. However, even in the actually serious event that the “main” key (which is, of course, present in every m.card) is discovered, this does not lead to a failure of the entire system since for this to happen, it would likewise be necessary to discover the well-secured signing key of the certification authority. Only through the interaction of the “main” key, the “media” key and the signing key is a simple and secure copy and utilization protection ensured.

Finally, the card can contain one or more keys that are used to secure the communication. For this purpose, a card-individual asymmetrical key pair pub_{card} and priv_{card} having a minimum key length of 1024 bits is provided. As an alternative, however, other key methods (e.g. symmetrical methods or methods based on elliptical curves) with other key lengths are possible. If there is sufficient storage space on the card on in the cryptographic module, a doubling to two asymmetrical key pairs is possible, whereby similar to a recommendation of the German Federal Agency for Security in Information Technology (Bundesamt für Sicherheit in der Informationstechnik—BSI), one of the key pairs is used exclusively for the decryption and one of the key pairs is used exclusively for the generation of digital signatures. If only one key pair is used (for the sake of a simplified representation), then during the card production, the public key of the card pub_{card} is certified by the issuing body or directly by the certification authority (in the latter case: sig_{CA}{card identity+pub_{card}}.), as a result of which, the association of the card number and the public key can be ensured reliably for third parties. Moreover, then a secure communication with any third party is possible in terms of confidentiality, integrity and enforceability.

Functions of the cryptographic module m.card

Thus, the cryptographic module of m.sec, the co-called m.card, fulfills several functions which can be listed as follows:
Carrying out the core functionalities of m.sec for storing and playing copy-protected and utilization-protected electronic audio and video media
These core functionalities can be seen in FIG. 2 (there: cryptographic module) and were explained in the preceding sections in relation to the playing and storing of audio and video media, and they concern primarily the execution of decryptions and encryptions with various of the above-mentioned keys.
Secure electronic communication
Secure electronic communication likewise relates primarily to the execution of encryptions and decryptions as well as the generation and verification of digital signatures for communication with communication partners, e.g. Internet-based servers. The communication does not relate to audio and video data, but rather to exchanging utilization and license fee information, to securely exchanging keys and to changing person-related and utilization-related data. All data that is exchanged between the communication partner and the cryptographic module can be secured in this manner by means of encryption and digital signature. For the use of the keys, see the last paragraph of the preceding section on the use of keys in the overall system.
Observing and complying with utilization rights
An important component of the exchanged and encrypted audio and video data is the utilization rights supplied together with this data. This refers to information about the type, scope and quality of the playing as well as information about whether and, if so, how many copies of the audio and video media are allowed to be made. Corresponding to this, the applicable license fees for the various modes of utilization are concurrently supplied.
The function of the cryptographic module is to acquire, to manage and to comply with the securely transmitted utilization information. The envisaged storage of copies or playback procedures by the user of the cryptographic module has to be executed or prevented by the cryptographic module on the basis of the utilization information.
Utilization information and utilization conditions can be stored temporarily or permanently in the cryptographic module in order to serve as a decision-making basis for playing, storing or license fee billing pertaining to further utilization.
Management of existing releases
Audio and video media that are stored for later playback according to the above-mentioned m.sec method can subsequently be played without further payment of license fees. In this case, the re-encrypted audio and video medium itself provides information about the executed release. This is different in the case of broadcast programs or unchangeable audio and video media such as CDs or DVDs, where re-encrypting cannot be carried out. Here, after the first-time release, the cryptographic module takes over the task of storing this release information. Two types of storage are possible here. First of all, “inbound” storage with which information about the release of a certain segment of a certain medium is saved securely inside the cryptographic module in such a way that the user cannot manipulate it without authorization. With “outbound” storage, information about the release of a certain segment of a certain medium is stored outside of the cryptographic module, for example, in the CD player, on a PC hard drive or in a central database in such a form that unauthorized manipulation of this information is not possible. This is achieved by the digital signature or encryption of this information by the cryptographic module.
In contrast, a playback by media that have already been released can only be carried out after the information saved in the cryptographic module has been checked. In particular, with the “outbound” method, before the playback, one's own digital signature has to be checked or a decryption has to be carried out inside the cryptographic module with a key contained only inside the cryptographic module.
Personal use of the cryptographic module
The cryptographic module is used by the individual recipient, that is to say, the legitimate owner of the m.card. In order to avoid unauthorized use of the m.card, an authentication of the legitimate user is carried out by entering a password or a “PIN” code. All of the actions performed by the cryptographic module, especially those that are relevant for license fees, may only be carried out by the cryptographic module once the legitimate user has been reliably authenticated.
Billing of license fees
An important task of the cryptographic module is to charge fees for the individual utilization of audio and video media or to provide information that allows the charging of license fees. Explanations on this can be found in the following section:
   Billing of license fees

In addition to the described processes of decryption and encryption of media data, the cryptographic module m.card also assumes the task of the billing of license fees. This is performed by the asymmetrical key pair or the key pair that has been doubled in terms of its application purpose.

The m.card fundamentally supports two types of billing:
1. So-called “credit” billing with which the type and scope of utilization are stored in or on the card in order to be transmitted to a billing station within the scope of a secure communication so that a bill can subsequently be issued.
2. So-called “debit” billing with which a cash value was previously transferred to the m.card via a secure modality and said value is reduced over the course of the utilization in accordance with the utilization conditions. The cash value can already be on the card at the time when the user purchases the m.card.

In both cases, before or after the proper use of the m.card, an electronic communication takes place with a billing station or loading station. This is where, in order to structure the communication, the certified public key of the m.card pub_{card} (including the certificate) is used, which allows the billing station or loading station to check the authenticity of the identity of the card (via the certificate) and, for the subsequent communication, to use the public key of the m.card to encrypt messages to the m.card. In exchange, the billing station or loading station transmits its public key, which was certified by the certification authority, to the m.card whose authenticity can be checked by means of the public key of the certification authority pub_{CA} that is stored in the card anyway. Subsequently, messages from the m.card to the billing station or loading station are encrypted by means of the public key of the billing station or loading station. If two key pairs are used for separate encryption and signature, then in each case, both certified public keys have to be transmitted to the communication partner.

When messages are exchanged between the m.card and the billing station or loading station, this can involve the following information:

from the m.card to the billing station or loading station:

certified card number/identity and public key (or two keys) within the scope of a certificate
intended action (e.g. billing or loading)
master data information and changes
preference information of the user (genre, language, billing modality, billing rate, etc.)
information about the licenses of audio and video media used (credit) or to be used (debit)
profile or log of the use so far
verification information for ensuring the security of the ongoing communication
receipt(s) for receiving the information and for terminating the communication
   from the billing station or loading station to the m.card:
certified identity of the billing station or loading station and public key (or two keys) within the scope of a certificate
intended action (e.g. billing or loading)
prompt to make or confirm master data information and changes
prompt to provide or confirm preference information of the user (genre, language, billing modality, billing rate, etc.)
receipt for the license values of audio and video media used (credit) or transmission of the license values to be used (debit)
information about the license and utilization conditions as well as fee and payment information
marketing information for the customer
verification information for ensuring the security of the ongoing communication
receipt(s) for receiving the information and for terminating the communication
   Practical use of cryptographic modules m.card

Cryptographic modules that comply with the m.sec method can be implemented as microprocessor-based systems, e.g. as integrated circuits. A preferred possibility in the implementation is a personal cryptographic module that is configured as a microprocessor chip card or as a dongle.

The cryptographic module m.card is used mainly for purposes of playing and storing released audio and video media. Consequently, the cryptographic module is practical in or on the periphery of potential playback and storage devices such as, for example, televisions sets, radios, CD players, DVD players, video recorders, video cameras, projection systems and PCs.

An appropriate installation of a chip card reading device in or on the playback or storage device or else of a plug for inserting the dongle is advantageous.

As an alternative, the cryptographic module can be used in a network-based mode. A possibility here, for instance, is the use of the cryptographic module at a central site (e.g. on the Internet) with which playback and storage devices can communicate via electronic networks.

In order to carry out billing procedures for license fees and viewing or changing master data and utilization conditions, it is advantageous to operate the cryptographic module together with a PC-based application program that supports the transactions by providing a graphic user interface.

1. A cryptographic module for storing and playing copy-protected and utilization-protected electronic audio and video media at a recipient, whereby the recipient's legitimate scope of utilization is regulated and enforced by the module, characterized in that the cryptographic module at the recipient completely or partially decrypts or deciphers encrypted or enciphered data contents of electronic audio and video media or else keys for decrypting these data contents—while observing the utilization rights and utilization conditions—and subsequently re-encrypts or re-enciphers them for purposes of storage or playback in such a way that license fees can be charged based on the utilization.

2. The method according to claim 1, characterized in that the authorization to use the cryptographic module to play and store audio and video media, to view and change utilization conditions and to charge for license fees is checked by means of the authentication of the legitimate user before the actual operation is carried out.

3. The method according to claim 1, characterized in that the reliability of the audio and video media is checked inside the cryptographic module on the basis of the validity of the certificate—issued by a credible certification authority—of a key of the publisher of the audio and video media, whereby this checking procedure is done by means of a test key of the certification authority that is saved in the cryptographic module.

4. The method according to claim 1, characterized in that the reliability of the portable device is checked inside the cryptographic module on the basis of the validity of the certificate—issued by a credible certification authority—of the portable device, whereby this checking procedure is done by means of a test key of the certification authority that is saved in the cryptographic module.

5. The method according to claim 1, characterized in that the reliability of electronic communication partners is checked inside the cryptographic module on the basis of the validity of the certificate—issued by a credible certification authority—of the communication partners, whereby this checking procedure is done by means of a test key of the certification authority that is saved in the cryptographic module.

6. The method according to claim 1, characterized in that the communications received from reliable electronic communication partners for the utilization of audio and video information are checked inside the cryptographic module for the validity of the applied digital signatures and are decrypted there.

7. The method according to claim 1, characterized in that the communications that are to be sent to reliable electronic communication partners and that are meant for the utilization of audio and video information are encrypted inside the cryptographic module and provided with their own digital signature there.

8. The method according to claim 1, characterized in that, while avoiding the processing of extensive audio and video data inside the cryptographic module, only key data for the decryption of this audio and video data is processed.

9. The method according to claim 1, characterized in that each processing of key data into encrypted audio and video information inside the cryptographic module leads to a decryption and subsequent different encryption of this key data—while the utilization conditions are observed.

10. The method according to claim 1, characterized in that the previous use of a user-related key employed by the cryptographic module itself to encrypt the audio and video data can be recognized and can be reversed again for purposes of playback.

11. The method according to claim 1, characterized in that the utilization conditions that were supplied with the audio and video data and that pertain to playing or storing this data are stored in the cryptographic module as the basis for re-encrypting procedures and license fee billing that are to be carried out.

12. The method according to claim 1, characterized in that the utilization rights and the utilization conditions are stored temporarily or permanently inside the cryptographic module so that, during the further utilization, they can serve as a decision-making basis for the playing, storing or license fee billing.

13. The method according to claim 1, characterized in that the license fee billing is done inside the module in such a way that the license fee billing can proceed in accordance with the utilization conditions, exclusively within the scope of the legitimate utilization, when re-encrypting procedures are carried out.

14. The method according to claim 1, characterized in that the use, in accordance with the license, of a user-related key for re-encrypting keys in order to play audio and video information is stored inside the cryptographic module, marking the specific section of the specific audio and video information with the identification of the release that has been effectuated in accordance with the license.

15. The method according to claim 1, characterized in that the use, in accordance with the license, of a user-related key for re-encrypting keys in order to play audio and video information is stored outside of the cryptographic module, marking the specific section of the specific audio and video information with the identification of the release that has been effectuated in accordance with the license and provided with a digital signature by the cryptographic module.

16. The method according to claim 1, characterized in that the cryptographic module is operated together with a PC-based application program that supports the transactions for use in accordance with the license by providing a graphic user interface.
